(19) United States
(12) Patent Application Publication
(10) Pub. No.: US 2013/0221555 A1
(43) Pub. Date: Aug. 29, 2013

(54) PROCESS FOR PRODUCING MOLDINGS

(71) Applicants: Andreas RADTKE, Mannheim (DE); Philippe Desbois, Edingen-Neckarhausen (DE); Andreas Wollny, Ludwigshafen (DE)

(72) Inventors: Andreas RADTKE, Mannheim (DE); Philippe Desbois, Edingen-Neckarhausen (DE); Andreas Wollny, Ludwigshafen (DE)

(73) Assignee: BASF SE, Ludwigshafen (DE)

(21) Appl. No.: 13/594,202

(22) Filed: Aug. 24, 2012

Related U.S. Application Data
(60) Provisional application No. 61/527,626, filed on Aug. 26, 2011.
(60) Provisional application No. 61/539,490, filed on Sep. 27, 2011.

(51) Int. Cl. B29C 45/00

(52) U.S. Cl. CPC B29C 45/0005
USPC 264/28; 264/257

(57) ABSTRACT

The invention relates to a process for producing moldings made of a fiber-reinforced polymer, comprising the following steps:

(a) inserting a fiber structure into a mold and injecting a polymer precursor compound around the fiber structure or saturating a fiber structure with a polymer precursor compound and inserting the saturated fiber structure into a mold, where the viscosity of the polymer precursor compound is at most 2000 mPas,

(b) polymerizing the polymer precursor compound to give the polymer, to produce the molding,

(c) removing the molding from the mold as soon as the polymerization process has proceeded at least to the extent that the molding is in essence dimensionally stable.

The invention relates to a process for producing moldings made of a fiber-reinforced polymer.

Fiber-reinforced polymers are used in fields requiring materials with high strength and with weight lower than that of metals. In particular, fiber-reinforced polymers are increasingly used in automobile construction, in order to reduce the mass of vehicles and thus reduce fuel consumption.

In a known method for producing fiber-reinforced polymers, fibers are first inserted into a mold and the polymer is then injected around these. A disadvantage here for producing thermoset materials is that there is no possibility of manufacturing a semifinished product. This method can only produce the fully finished plastics parts. A disadvantage of this for production of moldings, as a function of injection pressures, is that the textiles used for fiber reinforcement become deformed and displaced as a result of flow effects.

Other materials used in recent times alongside fiber-reinforced thermosets are those known as organopanels, i.e. fully consolidated continuous-fiber-reinforced thermoplastic polymers reinforced by textile or by laid scrim. The injection molding process can be used to inject polymers through said organopanels, if the organopanels are sufficiently thin or are heated above melting point.

In particular when injection molding processes are used to produce the components, high injection pressures are moreover needed, in order to permit compensation of large pressure losses during injection through the textile. Finally, displacement of the textile through flow effects causes the textile to deviate from the intended orientation. When steel textiles or steel cords are used, which unlike organopanels are not necessarily in fully consolidated form, the textile can be displaced toward the wall of the mold and thus toward the surface of the component, where it can become exposed or can become displaced through flow effects. A disadvantage here in particular in the case of steel textiles is that exposed steel can cause corrosion problems. During injection over steel textile it is moreover necessary to have a minimum wall thickness which is markedly greater than the thickness of the textile, in order to obtain complete enclosure of the textile by the polymer material. This increases the amount of material required and therefore leads to disadvantages in use of the fiber-reinforced polymers for lightweight structures.

It is therefore an object of the present invention to provide a process which can produce moldings made of fiber-reinforced polymers and which permits production of moldings with low wall thickness, and in which the inserted textiles are moreover not displaced as a result of the production process. The process is also intended to avoid exposure of fibers with resultant corrosion problems in particular when steel fibers are used.

Another object of the invention is to provide a process for producing semifinished products for the production of the moldings.

The object is achieved via a process for producing a semifinished product for producing moldings made of a fiber-reinforced polymer, comprising the following steps:

(i) inserting a fiber structure into a mold and injecting a polymer precursor compound around the fiber structure or saturating a fiber structure with a polymer precursor compound, where the viscosity of the polymer precursor compound is at most 2000 mPas,

(ii) freezing the polymer precursor compound or optionally partially polymerizing the polymer precursor compound to obtain the semifinished product.

From the semifinished product it is then possible to produce a molding made of a fiber-reinforced polymer, by completing reaction of the frozen or partially polymerized polymer precursor compound to give the polymer.

An advantage of the production of the semifinished product is that precursor products can be produced with less time in the mold. These can then, as a function of the shape of the semifinished product, be further processed as required to give different moldings. It is therefore possible, for example, to produce flat semifinished products which require less space in inventory than the finished moldings.

However, it is also possible, as an alternative, to produce the semifinished product in the shape of the finished molding and to complete polymerization outside of the mold after the freezing process or partial polymerization process which have produced a stable shape of the semifinished product. This again can result in less time in the mold, since production of the semifinished product needs less time in the mold than production of the fully polymerized molding.

It is preferable that the object is achieved via a process for producing moldings made of a fiber-reinforced polymer, comprising the following steps:
(a) inserting a fiber structure into a mold and injecting a polymer precursor compound around the fiber structure or saturating a fiber structure with a polymer precursor compound and inserting the saturated fiber structure into a mold, where the viscosity of the polymer precursor compound is at most 2000 mPas, or inserting a semifinished product into a mold,
(b) polymerizing the polymer precursor compound to give the polymer, to produce the molding,
(c) removing the molding from the mold as soon as the polymerization process has proceeded at least to the extent that the molding is in essence dimensionally stable.

It the viscosity of the polymer precursor compound used is at most 2000 mPas, preferably at most 1000 mPas, and in particular in the range from 5 to 500 mPas, it is possible to conduct the injection process at low pressure, both for production of the semifinished product and for production of the molding, thus avoiding or minimizing deformation of the inserted fiber structure as a result of the injection procedure. This moreover permits production of moldings with thickness only slightly greater than the thickness of the fiber structure. This permits saving of more material, and it is thus possible in particular to produce parts which comply with the requirements placed upon lightweight components.

Another advantage is that, by virtue of the low viscosity and the attendant possibility of using only low pressure to inject the polymer precursor compound, complete sheathing of the fiber structure is achieved, thus in particular avoiding exposure of metal fibers after production of the component when metallic fiber structures are used. The risk of corrosion of the metal parts is thus avoided.

The process of the invention permits not only the production of finished moldings and of semifinished products where the polymer precursor compound has been frozen or partially polymerized, but also production of moldings in the form of semifinished products with completely polymerized polymer matrix. When semifinished products with completely polymerized polymer matrix are produced, it is particularly preferable that the polymer precursor compound used comprises one which reacts to give a thermoplastic polymer. An advantage of a semifinished product made of a thermoplastic polymer is that the semifinished product can be subjected to a forming process via heating to give the finished component.

Another possibility, further, alongside the production of semifinished products, is production of finished moldings. In the case of finished moldings, the polymer precursor compound used can also be one which reacts to give a thermoset polymer.

In order to obtain adequate dimensional stability of the molding, it is preferable that the fiber structure is a woven, a knit, a laid scrim, a unidirectional or bidirectional fiber structure made of continuous fibers, or that it comprises unordered fibers. In particular if the fiber structure is a laid scrim, the arrangement can have individual fibers in a plurality of sublayers made of parallel fibers, and the individual sublayers here can have rotated orientation with respect to one another. It is particularly preferable here that the fibers of the individual sublayers have been rotated by an angle of from 30 to 90° with respect to one another. The rotated orientation of the individual sublayers with respect to one another increases the tensile strength of the molding in a plurality of directions. Unidirectional orientation increases tensile strength in particular in the direction of fiber orientation. The compressive strength of the component made from the molding is also increased perpendicularly with respect to the orientation of the fibers.

If the fiber structure comprises a woven or a knit, it is again possible to provide a plurality of sublayers, or only one sublayer, of fibers. In the case of a woven, the expression “a plurality of sublayers” implies that a plurality of wovens are to be arranged on top of one another. This also applies correspondingly to an arrangement of the fiber structure in the form of a knit.

Suitable fibers which can be used to increase the stability of the moldings are in particular carbon fibers, glass fibers, aramid fibers, metal fibers, polymer fibers, potassium titanate fibers, boron fibers, basalt fibers, or other mineral fibers. It is particularly preferable that at least some of the fibers used are metal fibers. Particularly suitable metal fibers are fibers based on ferrous metals, in particular based on steel.

In one particularly preferred embodiment, the fiber structure comprises steel cords, steel wire, or steel fibers. The fiber structure here can comprise exclusively steel cords, steel wires, or steel fibers, or can comprise a mixture made of steel cords, steel wires, or steel fibers and of non-metallic fibers, particularly preferably carbon fibers or glass fibers.

An advantage of using steel cords, steel wires, or steel fibers is that in particular it achieves high tensile strength of the resultant moldings. A substantial advantage of using steel cords in particular for use in vehicle construction is that component integrity is ensured on collision or impact, in situations where a structure reinforced by glass fiber or by carbon fiber would lose its integrity.

It is particularly preferable to use, for reinforcement, a mixture made of metal fibers and carbon fibers or glass fibers. In this case it is possible, for example, to weave individual steel cords, steel wires, or steel fibers together with carbon fibers or glass fibers. As an alternative, it is also possible to insert different fibers in the form of a laid scrim into the mold. The fibers here can be inserted either in alternation or in any desired randomly distributed sequence. Another possibility is, for example, to insert fibers made of one particular material in one orientation and fibers made of another material in an orientation rotated with respect to said orientation.

In particular when steel cords, steel wires, or steel fibers are used, it is preferable to produce a woven by weaving these together with glass fibers or carbon fibers. Uniform reinforcement of the molding can then be achieved, for example, by arranging the individual wovens with rotation with respect to one another in a plurality of sublayers. By way of example, it is therefore possible to use two sublayers rotated by 90° with respect to one another. It is also possible to use any desired other angle as an alternative. It is also possible to use more than two sublayers.

Moldings with improved failure performance can be produced by using metal fibers, for example in the form of steel cords, steel wires, or steel fibers together with fibers made of another material, for example carbon fibers or glass fibers. By way of example, use of the polymer precursor compound which is injected around, or saturates, the fiber structure can increase the time for which a resultant molding resists failure through fracture after it is subjected to mechanical stress. The molding can thus absorb a greater load without failure. Another possibility is, for example, to produce thermoplastic polymer components which have not only the properties afforded by carbon fiber reinforcement but also deformation behaviour similar to that of a metal.

The polymer precursor compound is, as a function of the polymer to be produced, by way of example caprolactam, laurolactam, cyclobutylene terephthalate, or cyclic polybutylene terephthalate. It is also possible to use polymer precursor compounds which react to give polymethyl methacrylate, polybutylene terephthalate, polyethylene terephthalate, polycarbonate, polyether ether ketone, polyether ketone, polyether sulfone, polyphenylene sulfide, polyethylene naphthalate, polybutylene naphthalate, or polyamide. The polymer precursor compounds here can be either monomers or oligomers of the polymers to be produced. The only essential consideration here is that the viscosity of the polymer precursor compound remains below 2000 mPas. The viscosity of the polymer precursor compound is particularly preferably in the range from 5 to 500 mPas, very particularly preferably in the range from 5 to 100 mPas.

If caprolactam is used as polymer precursor compound, it is preferable that the temperature of the polymer precursor compound during saturation of, and/or injection around, the fiber structure is in the range from 100 to 120° C., preferably in the range from 105 to 115° C. An appropriate temperature of the polymer precursor compound generally gives a viscosity sufficiently low to achieve uniform wetting of the fiber structure. In this case, the temperature of the mold into which the polymer precursor compound is injected, or within which the molding is finally shaped, is preferably in the range from 140 to 180° C., particularly preferably in the range from 150 to 160° C.

If cyclobutylene terephthalate is used as polymer precursor compound, the temperature to which the mold is heated is preferably in the range from 180 to 200° C. If polymer precursor compounds for producing nylon-12 are used, the molding is preferably heated to a temperature in the range from 180 to 240° C., and if polymer precursor compounds for producing polyethylene terephthalate are used, the molding is preferably heated to a temperature in the range from 250 to 325° C., and if polymer precursor compounds for producing polycarbonate are used, the molding is preferably heated to a temperature in the range from 240 to 280° C., and if polymer precursor compounds for producing polyethylene sulfone are used, the molding is preferably heated to a temperature around 300° C.

Use of the polymer precursor compound which is injected around, or saturates, the fiber structure achieves uniform complete wetting of the fiber structure, thus permitting production of a component with strength properties improved over those obtained in conventional processes in which a molten polymer is injected around the fiber structure. A particular achievement of the use of the polymer precursor compound is that the fiber structure used is completely wetted by the polymer precursor compound and thus, after the reaction, by the polymer.

In order to adjust the properties of the polymer, the polymer precursor compound can moreover also comprise comonomers for producing a copolymer, or additives. Examples of additives usually used are hardeners, crosslinking agents, plasticizers, catalysts, impact modifiers, adhesion promoters, fillers, mold-release agents, blends with other polymers, stabilizers, or a mixture of two or more of said components. The person skilled in the art is aware of comonomers or additives which can be used to adjust the properties of the polymer.

In order to obtain a dimensionally stable molding by the process of the invention, it is particularly preferable that the molding is removed from the mold only after complete polymerization. After complete polymerization the molding is dimensionally stable, and there is thus no residual risk that the molding will be damaged, in particular deformed, during demolding.

In order to obtain complete wetting of the fiber structure, it is possible to saturate the fiber structure with a polymer precursor compound prior to the insertion process and injection process in step (a) and, respectively, in step (i) for the production of a semifinished product. The saturation of the fiber structure by the polymer precursor compound achieves complete wetting, irrespective of the subsequent shaping process. Another result achieved, during the injection process in step (a) and, respectively, (i), through the saturation of the fiber structure with the polymer precursor compound is better adhesion of the polymer precursor compound which is injected around the fiber structure.

In particular if, prior to the insertion process and injection process in step (a) and, respectively, (i), the fiber structure is saturated with a polymer precursor compound, it is possible to use different polymer precursor compounds for the saturation process and for the injection process. However, a general requirement in this case is that the polymer precursor compound which has been used to saturate the fiber structure is first completely hardened, and that, in the next step, the fiber structure that has already been saturated and completely hardened is inserted into the mold so that the next polymer precursor compound can be injected around same. Another possibility, as an alternative, is to take a semifinished product with frozen or partially polymerized polymer precursor compound and then inject another polymer precursor compound around same to produce a molding.

In order to obtain improved adhesion of the polymer on the fiber structure, it is moreover possible to pretreat the fiber structure with a primer prior to the injection process or saturation process in step (a) and, respectively, (i). The primer here can by way of example also serve as adhesion promoter between fiber structure and polymer. An example of a material suitable for the primer is a soluble polyamide. This is applied in solution form and the solvent is then removed. A soluble polyamide is particularly suitable when the process of the invention is intended to produce a molding made of a fiber-reinforced polyamide.

If the intention is first to saturate the fiber structure with a polymer precursor compound, before the fiber structure is inserted into the mold for producing the molding, it is particularly advantageous that the monomers comprised in the polymer precursor compound polymerize at least to some extent after the saturation process and prior to insertion of the fiber structure saturated with the polymer precursor compound. This gives a semifinished product while in particular avoiding possible expulsion and escape of monomers which have been used to saturate the fiber structure and which have not undergone complete hardening. The entire amount of polymer precursor compounds used to saturate the fiber structure remains within the fiber structure, and is used in the shaping of the component. This ensures uniform and complete wetting of the fiber structure by the saturation process. It is possible to establish local differences in fiber contents or in combinations by varying the shape and nature of the fiber structure and/or varying the way in which the polymer precursor compound is charged.

The molding produced by the process of the invention, made of the fiber-reinforced polymer, is particularly advantageously a structural component, a bulkhead, a floor assembly, a battery holder, a side-impact member, a bumper system, a structural insert, or column reinforcement in a motor vehicle. The fiber-reinforced polymer is also suitable for producing side walls, structural wheel surrounds, longitudinal members or upper longitudinal members, or any desired other components of vehicle bodywork.

A particular feature of the components produced via the process of the invention is better retention of integrity of the component for example after mechanical stress, for example after an accident involving a motor vehicle which comprises a molding made of fiber-reinforced polymers. When fractures occur, the interior integrity of the component is retained, and the overall integrity of the component is retained. Plastic deformation can be enabled by combining unreinforced or slightly reinforced polyamide with steel cords. Another advantage of plastic deformation of the component without fracture is that there is no production of sharp-edged fractures which can cause injury.

In particular, the process of the invention permits production of components which not only have properties of conventional fiber-reinforced polymers, in particular the compressive and tensile strength of these, but also have deformation performance close to that of a metallic component. Deformation performance close to that of a metallic component is in particular achieved via use of metal fibers, in particular steel cords, steel wires, or steel fibers.

In order to obtain moldings with a high-quality surface, the molding can be provided with what is known as an in-mold coating. For this, the surface coating of the component is produced directly within the mold. Unlike conventional coating processes, this gives good adhesion of the coating material on the molding, and the coating achieved is therefore of particularly high quality.

The process of the invention is suitable not only for producing components for a motor vehicle but also for producing housings, for example for a stone mill, or for the production of a protective cage or of a housing for a turning machine or for a milling machine. The process of the invention can also produce any desired other moldings, e.g. housings for hand-held devices. It is particularly advantageous here that the process of the invention can produce housings where mechanical stress, for example caused by dropping, does not lead to break-off of any parts of the supportive housing.

### EXAMPLE

A knitted fabric made of steel fibers and carbon fibers is inserted into a mold for producing a molding. After closure, caprolactam is injected at a temperature of 112° C. as polymer precursor compound into the mold. The mold is heated to a temperature of 155° C. The heating of the mold hardens the caprolactam to give to give the corresponding polyamide. The viscosity of the caprolactam at injection temperature is 5 mPas.

After a period of from 2 to 3 minutes, the caprolactam has completed its reaction to the extent that the molding can be removed from the mold.

The glass transition temperature of the polyamide from which the molding has been manufactured is 60° C. and its melting point is 220° C. Modulus of elasticity is 3400 mPa and tensile strain at break is 20 percent.

A particular feature of a molding produced in this way is that the fiber structure sheathed by the polymer has been covered completely by the polymer and that there are no exposed parts of the fiber structure. There was also found to be no displacement of the fiber structure within the molding.

The proportion of fibers, based on the total volume of the molding, is up to 70 percent by volume.

1. A process for producing a semifinished product for producing moldings made of a fiber-reinforced polymer, comprising the following steps:
(i) inserting a fiber structure into a mold and injecting a polymer precursor compound around the fiber structure or saturating a fiber structure with a polymer precursor compound, where the viscosity of the polymer precursor compound is at most 2000 mPas,
(ii) freezing the polymer precursor compound or partially polymerizing the polymer precursor compound to obtain the semifinished product.

2. A process for producing moldings made of a fiber-reinforced polymer, comprising the following steps:
(a) inserting a fiber structure into a mold and injecting a polymer precursor compound around the fiber structure or saturating a fiber structure with a polymer precursor compound and inserting the saturated fiber structure into a mold, where the viscosity of the polymer precursor compound is at most 2000 mPas, or inserting a semifinished product into a mold,
(b) polymerizing the polymer precursor compound to give the polymer, to produce the molding,
(c) removing the molding from the mold as soon as the polymerization process has proceeded at least to the extent that the molding is in essence dimensionally stable.

3. The process according to claim 1, wherein the fiber structure is a woven, a knit, a laid scrim, or a unidirectional or bidirectional fiber structure made of continuous fibers, or comprises unordered fibers.

4. The process according to claim 1, wherein fibers used for the fiber structure comprise carbon fibers, glass fibers, aramid fibers, metal fibers, polymer fibers, potassium titanate fibers, boron fibers, basalt fibers, or mineral fibers.

5. The process according to claim 1, wherein the fiber structure comprises steel cords, steel wires, or steel fibers.

6. The process according to claim 5, wherein the fiber structure is a woven or a knit made of steel cords, steel wires, or steel fibers, and carbon fibers, or glass fibers.

7. The process according to claim 1, wherein the polymer precursor compound comprises caprolactam, laurolactam, cyclobutylene terephthalate, or cyclic polybutylene terephthalate.

8. The process according to claim 1, wherein the polymer precursor compound comprises monomers or oligomers for producing polymethyl methacrylate, polybutylene terephthalate, polyethylene terephthalate, polycarbonate, polyether ether ketone, polyether ketone, polyether sulfone, polyphenylene sulfide, polyethylene naphthalate, polybutylene naphthalate, or polyamide.

9. The process according to claim 1, wherein the polymer precursor compound further comprises comonomers for producing a copolymer, hardeners, crosslinking agents, plasticizers, catalysts, impact modifiers, adhesion promoters, fillers, mold-release agents, blends with other polymers, stabilizers, or a mixture of two or more of said components.

10. The process according to claim 1, wherein the molding is removed from the mold after complete polymerization.

11. The process according to claim 1, wherein, prior to the insertion and injection process in step (a), the fiber structure is saturated with a polymer precursor compound.

12. The process according to any claim 1, wherein local differences in fiber contents or in combinations are established by varying the shape and nature of the fiber structure and/or varying the way in which the polymer precursor compound is charged.

13. The process according to claim 1, wherein the fiber structure is pretreated with a primer prior to the injection process or saturation process in step (a).

14. The process according to claim 1, wherein the monomers comprised in the polymer precursor compound polymerize at least to some extent after the saturation process and prior to insertion of the fiber structure saturated with the polymer precursor compound.

15. The process according to claim 1, wherein the molding made of the fiber-reinforced polymer is a structural component, a bulkhead, a floor assembly, a battery holder, a side-impact member, a bumper system, a structural insert, column reinforcement, a side wall, a structural wheel surround, a longitudinal member, or an upper longitudinal member of a motor vehicle.

16. The process according to claim 1, wherein the molding made of the fiber-reinforced polymer is a housing of a stone mill, or is a protective cage or housing for a turning machine or for a milling machine, or is a housing for a hand-held device.

17. The process according to claim 2, wherein the fiber structure is a woven, a knit, a laid scrim, or a unidirectional or bidirectional fiber structure made of continuous fibers, or comprises unordered fibers.

18. The process according to claim 2, wherein fibers used for the fiber structure comprise carbon fibers, glass fibers, aramid fibers, metal fibers, polymer fibers, potassium titanate fibers, boron fibers, basalt fibers, or mineral fibers.

19. The process according to claim 2, wherein the fiber structure comprises steel cords, steel wires, or steel fibers.

20. The process according to claim 19, wherein the fiber structure is a woven or a knit made of steel cords, steel wires, or steel fibers, and carbon fibers, or glass fibers.

21. The process according to claim 2, wherein the polymer precursor compound comprises caprolactam, laurolactam, cyclobutylene terephthalate, or cyclic polybutylene terephthalate.

22. The process according to claim 2, wherein the polymer precursor compound comprises monomers or oligomers for producing polymethyl methacrylate, polybutylene terephthalate, polyethylene terephthalate, polycarbonate, polyether ether ketone, polyether ketone, polyether sulfone, polyphenylene sulfide, polyethylene naphthalate, polybutylene naphthalate, or polyamide.

23. The process according to claim 2, wherein the polymer precursor compound further comprises comonomers for producing a copolymer, hardeners, crosslinking agents, plasticizers, catalysts, impact modifiers, adhesion promoters, fillers, mold-release agents, blends with other polymers, stabilizers, or a mixture of two or more of said components.

24. The process according to claim 2, wherein the molding is removed from the mold after complete polymerization.

25. The process according to claim 2, wherein, prior to the insertion and injection process in step (a), the fiber structure is saturated with a polymer precursor compound.

26. The process according to claim 2, wherein local differences in fiber contents or in combinations are established by varying the shape and nature of the fiber structure and/or varying the way in which the polymer precursor compound is charged.

27. The process according to claim 2, wherein the fiber structure is pretreated with a primer prior to the injection process or saturation process in step (a).

28. The process according to claim 2, wherein the monomers comprised in the polymer precursor compound polymerize at least to some extent after the saturation process and prior to insertion of the fiber structure saturated with the polymer precursor compound.

29. The process according to claim 2, wherein the molding made of the fiber-reinforced polymer is a structural component, a bulkhead, a floor assembly, a battery holder, a side-impact member, a bumper system, a structural insert, column reinforcement, a side wall, a structural wheel surround, a longitudinal member, or an upper longitudinal member of a motor vehicle.

30. The process according to claim 2, wherein the molding made of the fiber-reinforced polymer is a housing of a stone mill, or is a protective cage or housing for a turning machine or for a milling machine, or is a housing for a hand-held device.

31. A process for producing a molding made of a fiber-reinforced polymer, in which the polymer precursor compound of a semifinished product produced according to claim 1 is reacted to completion to give the polymer after the freezing process or partial polymerization process.
